(19) United States
(12) Patent Application Publication
(10) Pub. No.: US 2014/0308400 A1
(43) Pub. Date: Oct. 16, 2014

(54) POLYPHENOL AND METAL IONS FOR BROWNING FOOD SURFACES

(71) Applicants: Karlheinz Bortlik, Syens (CH); Martin Michel, Lausanne (CH); Sandrine Cavin, Epalinges (CH)

(72) Inventors: Karlheinz Bortlik, Syens (CH); Martin Michel, Lausanne (CH); Sandrine Cavin, Epalinges (CH)

(73) Assignee: NESTEC S.A., Vevey (CH)

(21) Appl. No.: 14/357,730

(22) PCT Filed: Aug. 17, 2012
(86) PCT No.: PCT/EP2012/066110

§ 371 Date: May 12, 2014

(30) Foreign Application Priority Data
Nov. 11, 2011 (EP) 11188817.8
Nov. 11, 2011 (US) 61558510

(51) Int. Cl. A23L 1/00

(52) U.S. Cl. CPC A23L 1/0047
USPC 426/89; 426/268; 426/531

(57) ABSTRACT

The present invention relates to a food product coated on a surface with a compound with at least one aromatic ring having at least two hydroxyl groups borne by two adjacent carbon atoms to that aromatic ring, and ions of a transition metal. Embodiments of the invention further relate to a method for coloring a surface of a food product when heated for example in a microwave oven, and a composition comprising the compound and the transition metal ions.

The present invention relates to a food product coated on a surface with a compound with at least one aromatic ring having at least two hydroxyl groups borne by two adjacent carbon atoms to that aromatic ring, and ions of a transition metal. Embodiments of the invention further relate to a method for coloring a surface of a food product when heated for example in a microwave oven, and a composition comprising the compound and the transition metal ions.

The usage of microwave ovens in homes has increased significantly in recent years and continues to increase. While microwave cooking of foods affords a significant time saving over conventional oven cooking, it suffers from the disadvantage that food products cooked by microwave energy lack the desired degree of surface browning, that particularly those have that have a crust, such as pies, pizzas, bread, dough's etc. have when cooked in a conventional oven.

The most common reaction responsible for surface browning during cooking of products having a dough crust is the well-known Maillard reaction (i.e. non-enzymatic browning). This reaction occurs between naturally occurring reducing sugars and compounds containing an amino group, e.g. amino acids, peptides and proteins, and results in the formation of colored melanoidins. The rate at which the Maillard reaction proceeds to form such colored pigments increases significantly with temperature and time. When foods containing a dough crust, such as for example a frozen pizza, a bread or a snack, are heated in a conventional oven, the crust is heated to considerably higher temperatures than the interior of the food product, with the high surface temperatures being sufficient to achieve the desired browning.

However, in microwave heating the heat energy is released internally within the food product so that the surface remains at a relatively even temperature with the interior. There is a lack of hot, dry air surrounding the food product during microwave cooking. In addition, the food is usually cooked for a much shorter time. Consequently, the high surface temperatures necessary to achieve browning are not reached within the time required to bake the food product. The surface of the product remains moist and pale: the desired development of a nice brown surface color does not appear. The end-product, although well cooked, is often perceived as under-cooked by the consumer.

A number of compositions have been proposed to create a desirable browned surface of a food product when heated by microwave energy. Such prior microwave browning compositions typically are based on the Maillard reaction to effect browning, and include one or more components which permit the reaction to take place at lower temperatures or which increase the reaction rate. Such compositions typically include carbohydrates such as for example dextrose, maltodextrin and acetaldehyde compounds which result from pyrolysis of some of the sugar compounds prior to constitution of the browning composition (see U.S. Pat. No. 5,756,140). However, none of these prior compositions have been entirely satisfactory due to flavor concerns, the limitation of achievable color variations on a food product and costs. Further, the presence of acetaldehydes and potentially still other compounds from the pyrolysis process may be perceived as less natural by consumers.

EP0481249 proposes a method to use an amount of water soluble tea solids applied to a food surface to develop a browned surface on the crust of such a food when heated by microwave energy. The shortcoming of the proposed method is that food products treated with such soluble tea solids retain a distinct flavor and taste of black tea. For most product applications, this is clearly not desired. It is believed that this significant flavor impact is due to the fact that a relatively high concentration of tea solids is needed to be applied to the food surface in order to be effective for the development of a desired surface coloration. A further major inconvenience of the application is that the food surface remains moist and soft. Hence, this solution does not provide the consumer with the impression of a well-cooked product with a well-developed crust.

Currently on the market and commercially used is “Liquid or powder Smoke” (Red Arrow Products Company LLC, Manitowoc, Wis., USA). “Liquid or Powder Smoke” overcomes the currently missing solution for fast browning of food surfaces in microwave applications. However, “Liquid Smoke” may not be well perceived by consumers. It contains aldehydes which have to be labeled on the packaging of the food products. Currently, the EFSA (European Food Safety Authority) is investigating the safety of “Liquid Smoke” as a food flavoring agent.

Hence, there is a continuous need in the industry to replace the existing solutions and find new ones which make use of natural, safe and consumer friendly compositions which can effectively be used on food products for inducing coloration of food surfaces upon heating for example in a microwave oven. Further, it would also be desirable to have some alternative solutions which would provide new and different color variations within the brown color range after a heating process of a food product. These compositions should be odorless or at least not having a negative impact on the final flavor of such a treated food product.

The object of the present invention is to provide an improved solution for coloring surfaces of food products to be heated thereafter, for example in a microwave oven, and which overcomes at least some of the inconveniences described above.

The object of the present invention is achieved by the subject matter of the independent claims. The dependent claims further develop the idea of the present invention.

Accordingly, the present invention pertains to a food product with a coating on a surface, the coating comprising i) a compound with at least one aromatic ring having at least two hydroxyl groups borne by two adjacent carbon atoms of that aromatic ring, and ii) an ion of a transition metal.

In a second aspect, the invention relates to a method for coloring a surface of a food product when heated, comprising the steps of i) coating the surface with a coating comprising a compound with at least one aromatic ring having at least two hydroxyl groups borne by two adjacent carbon atoms of that aromatic ring and an ion of a transition metal, and ii) heating the food product thereafter in order to develop a color of the surface.

A further aspect of the invention is a composition for coating a food product comprising i) a compound with at least one aromatic ring having at least two hydroxyl groups borne by two adjacent carbon atoms of that aromatic ring in a concentration from 1 to 100 mg/ml, preferably from 2.5 to 10 mg/ml, ii) an ion of a transition metal in a concentration from 0.2 to 100 mMol, preferably from 2 to 10 mMol, and iii) water.

The inventors surprisingly found that appealing brownish colors develop on the surface of a food product during heating, particularly during heating in a microwave oven, if such surface has been coated with a compound with at least one aromatic ring having at least two hydroxyl groups borne by two adjacent carbon atoms of that aromatic ring in combination with ions from a transition metal prior to the heating step. Depending on the choice of the transition metal ions in combination with the compound, the appearance of the brownish color can be even more intensified and/or give raise to interesting new color variations within the brown range of the color spectrum.

This finding can advantageously be applied to coat un- or prebaked food products with a transparent and colorless surface coating, which upon baking in for example a microwave oven develop a brown color of the food product surface. It is of great advantage that the compound occurs naturally in many edible plant materials and extracts thereof such as for example in tea, coffee and grapes, and hence that its use in combination with transition metal ions is a natural and safe solution.

Furthermore, the combination of the compound with transition metal ions produces a synergistic effect which intensifies the development of a surface color upon heating in comparison of for example using only tea extract in isolation. Thereby, it is now possible to significantly reduce the amount of for example tea extract to be used for coating a food product surface. This has the great advantage that much less of a phenolic compound has to be applied to a given food surface. This dramatically reduces the effect of softening said food surface and results after heating in a product with a dry and improved aspect of the food surface. It now leaves the consumer with the impression of a well-cooked product with a well developed crust.

A still further advantage of a reduced need of for example tea extract when combined with a transition metal ion for coating a food surface is that the distinct flavor and taste impact of said tea extract on a product is now reduced significantly. This allows considering much broader product applications where for example a perceived flavor or taste of tea extract would not have been acceptable by the consumer. Particularly, the astringency potentially related to a tea or other phenolic extract can be reduced in this way.

Although not wishing to be bound by theory, the inventors think that the presence of transition metal ions catalyzes to some extent oxidation reactions of polyphenols at the site of their ortho-dihydroxy phenyl group and thereby forming precursors which will lead to the observed browning reactions.

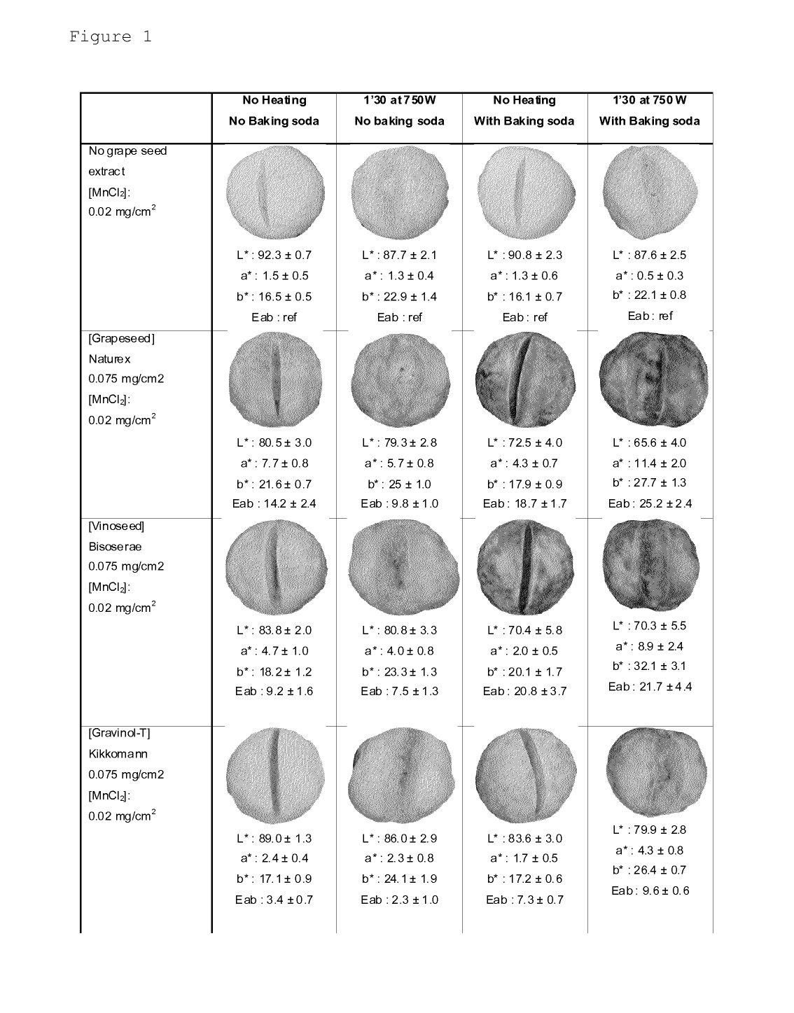

FIG. 1: Browning reaction of grape seed extract coated on a dough surface applied with and without Mn ions before and after heating in a microwave oven.

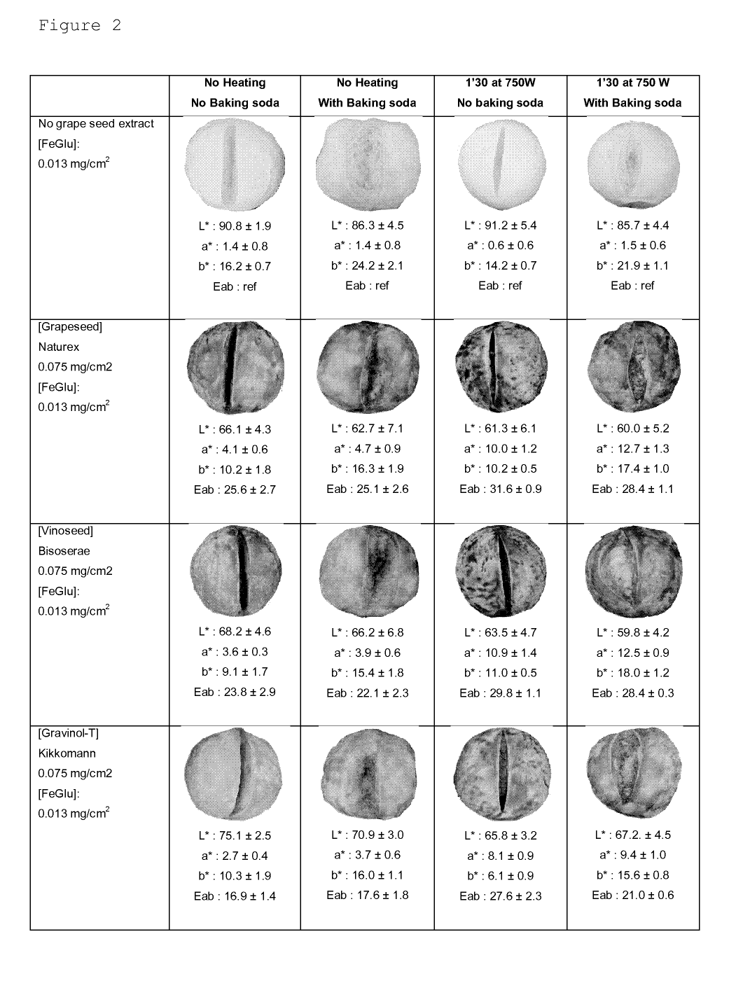

FIG. 2: Browning reaction of grape seed extract coated on a dough surface applied with and without Fe ions before and after heating in a microwave oven.

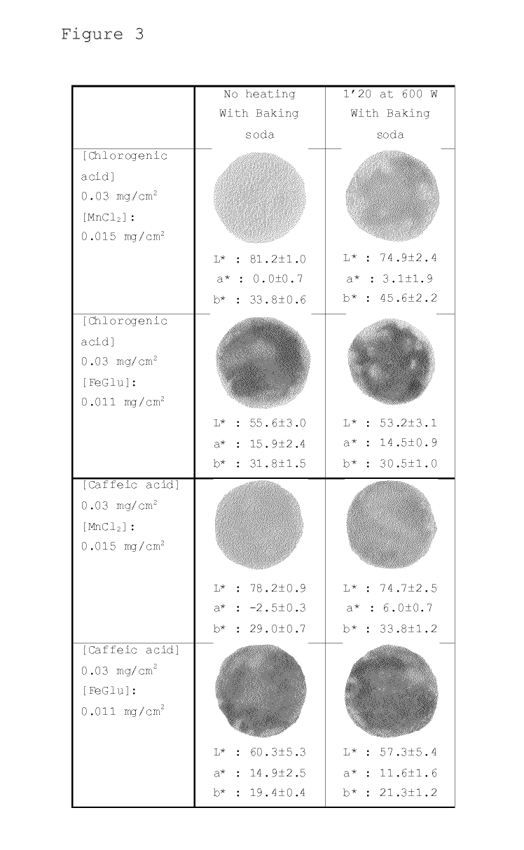

FIG. 3: Browning reaction of dough surface coatings comprising caffeic and chlorogenic acid with the addition of Mn and Fe ions before and after heating in a microwave oven.

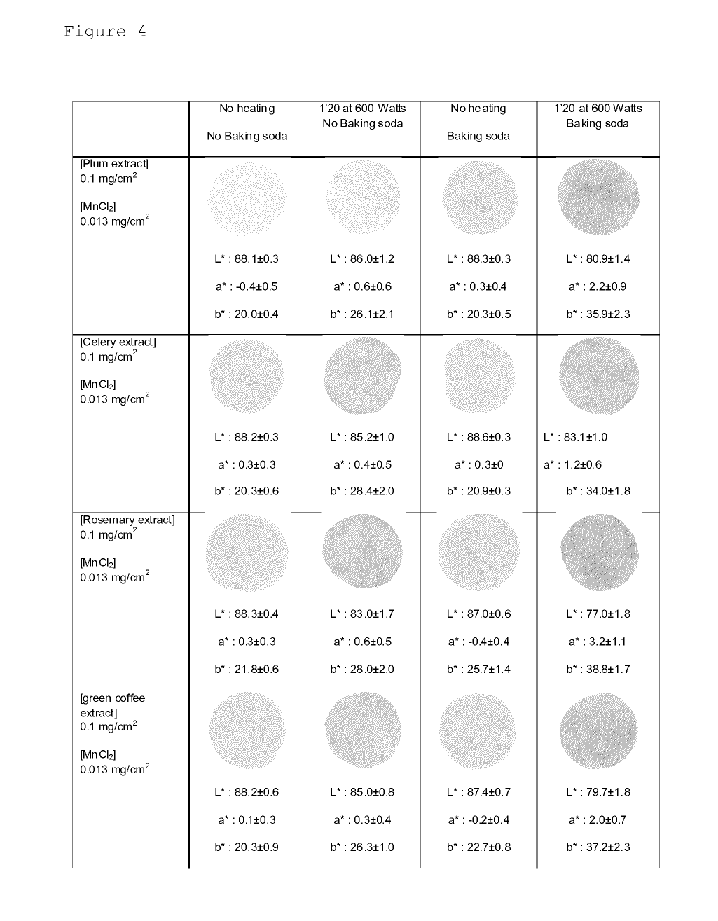

FIG. 4: Browning reaction of dough surface coatings comprising caffeic and chlorogenic acid from plant extracts with the addition of Mn ions before and after heating in a microwave oven.

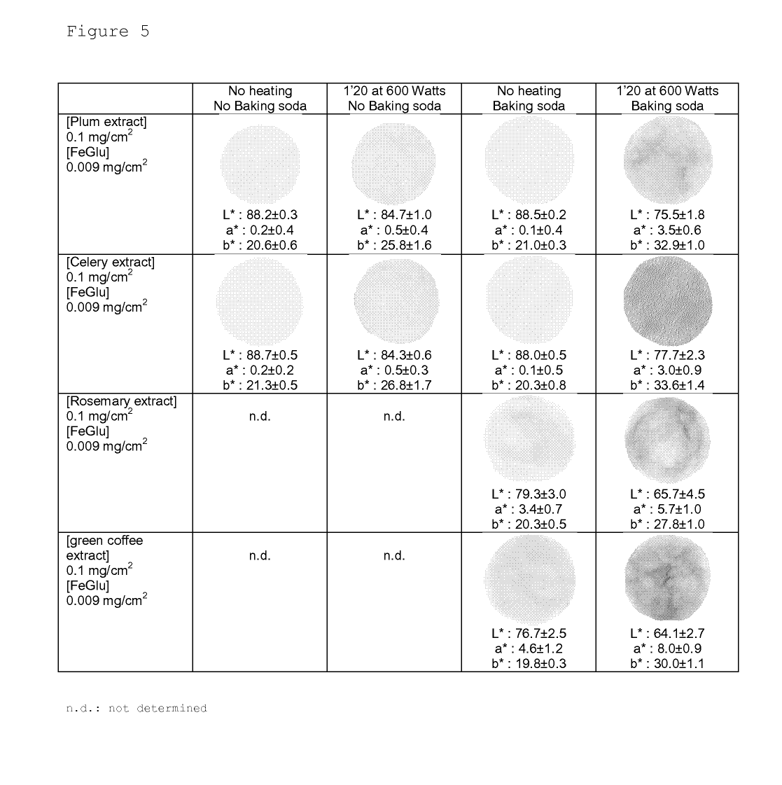

FIG. 5: Browning reaction of dough surface coatings comprising caffeic and chlorogenic acid from plant extracts with the addition of Fe ions before and after heating in a microwave oven.

The present invention pertains to a food product with a coating on a surface, the coating comprising i) a compound with at least one aromatic ring having at least two hydroxyl groups borne by two adjacent carbon atoms of that aromatic ring, and ii) an ion of a transition metal.

In a preferred embodiment, the coating of the present food product is colorless before the food product is being heated.

Thereby, a “colorless coating” is understood as a coating on a food product surface which is transparent and without color. Hence, the colorless coating does not provide an own, proper color to the food product surface. A consumer looking at a food product with such a defined surface coating will not perceive a color coming from the coating per se.

The advantage is that a consumer would perceive such a coated un- or pre-baked food product as indeed still un- or pre-baked. Upon baking for example in a microwave oven, the baked product would then develop in parallel with the baking process a nice, brown surface coloring appearance, indicating to the consumer that the product is now baked as e.g. in a traditional oven. This allows producing microwavable food products which have a visual aspect after microwave baking similarly or identical to same products but baked in a conventional oven.

The product of the invention can be coated on just one or several surfaces, if available. Preferably, the surface selected for the coating is the exterior face or part of the exterior face of the product which is visible upon presentation of the food product to a consumer.

The food product according of the invention pertains also to such products, wherein the surface is only partly coated with the compound and the transition metal ions. Partly meaning a part of the entire product surface is coated or treated. This allows inducing a colored surface of only certain parts of a food product, to apply for example certain designs or figures which only appear in color after heating or baking of the product. Further, pictures or short texts could be produced on food surfaces in the same way as well.

Preferably, the compound is an ortho-dihydroxy phenol derivative, selected from the group consisting of caffeic acid, cholorogenic acid, rosmarinic acid, caftaric acid, quercetin, catechin, epi-catechin and (epi)-gallocatechin, or a combination thereof.

Thereby it is of an advantage that such ortho-dihydroxy phenolic and polyphenolic compounds naturally occur in nature and specifically in many fruits, vegetables and herbs which are safely consumed by humans and/or animals since hundreds of years. Those compounds are well recognized by consumers and also by legislators world-wide as food grade and safe to consume.

The compound of the invention may be provided in the form of a plant extract. Ortho-dihydroxy phenolic and polyphenolic compounds according to claim 1 naturally occur in many plant materials. It is of an advantage that extracts from such plants, for example from their fruits, leaves or roots can be used as a natural source thereof. Thereby, the said compounds can be extracted and purified from those plant materials. Alternatively, the extracts themselves or just the partly purified compounds from those sources can be used. For the latter extracts, the products would have a still better acceptance with consumers as they would be considered even more ‘natural’. Furthermore, production costs would be significantly lower than if the said compounds would have to be produced synthetically or purified from a plant material to homogeneity.

The plant extract may be selected from fruits, vegetables, seeds, roots, herbs or spices. Preferably, the plant extract is selected from the group consisting of tea, coffee, grape, grape seed, plum, celery, basil, thyme, oregano, rosemary and onion extract, or a combination thereof. Those plant extract are all rich in either a one or several of those o-dihydroxy phenolic compounds. Further, they are all well accepted by consumers as food products themselves. They are food grade and safe to consume.

In an embodiment, the amount of the compound on the surface of a food product is in the range from 0.001-1.0 mg/cm², preferably from 0.01-0.5 mg/cm², more preferably from 0.06-0.2 mg/cm². These concentrations of the compound on the food surface allow on one hand to provide a practically in-color food product surface coating before the baking or heating step, and on the other hand allow the food surface to develop a sufficiently satisfying color appearance after the heating in for example a microwave oven.

The food product of the invention is further coated with an ion of a transition metal, wherein the amount of the ion of a transition metal on the surface of said product is in the range from 0.00001-1.0 mg/cm², preferably from 0.0001-0.1 mg/cm², more preferably from 0.001-0.05 mg/cm².

It has been observed that the presence of transition metal ions together with the compound as of claim 1 has a synergistic effect in further and faster developing the color reaction at a food surface. Hence, in selecting appropriate concentrations of transition metal ions versus the structure of the compound, the intensity and speed of the surface color development can be modified and optimized according to individual specific food applications and preferences.

The metal ions are of a transition metal, wherein the transition metal is selected from the group consisting of Fe, Mn, Co, Cr, Zn and Cu, or a combination thereof. Preferably, the transition metal is selected from the group consisting of Zn, Fe, Cu and Mn, or a combination thereof. Different metal ions react differently together with the compound, resulting in slightly but distinct different color appearances within the brownish range of the color spectrum. This again allows adapting not only color intensity but also the color per se for an individualized use of the invention according to the desired product application.

The food product of the invention is to be heated, and particularly so, the surface of said food product is to be heated. Typically, such heating can be achieved in a conventional oven or by any other means of heating a product or its surface such as for example by exposing the product to a heating lamp or infrared heater. Preferably, the product of the invention is to be heated in a microwave oven.

It is mainly for food products intended to be heated for a short time only and at relative lower surface temperatures that the invention provides a good solution to surface coloring. Hence, the invention is advantageously applied on food products intended for being heated in a microwave oven. For example, food products of the present invention are heated for at least 2 min at 250 Watts or higher, preferably for at least 4 min at said Watts in a microwave oven. Alternatively, the food products are heated for 1 min and 20 seconds or longer in a microwave oven at 600 Watts or higher.

The food product according to the invention mainly pertains, but is not limited, to products selected from the group consisting of dough, bread, cookies, cereals, bakery products, pizzas, snacks, gratins, cooked pasta, lasagna, cheese and rice dishes, and meat.

Preferably, the food product is a frozen food product before being heated e.g. in a microwave oven. For example, the product is a frozen pizza; a frozen dough or bread product such as a Panini or Hot Pocket product; a frozen gratin, pasta, lasagna, cheese or rice dish.

The advantage of the invention for an application to a frozen food product is that the colorless coating is more stable and remains quasi invisible for a long period of storage, before developing the desired brown surface color upon the heating step, e.g. in a microwave oven.

A further aspect of the invention is a method for coloring a surface of a food product when heated, comprising the steps of i) coating the surface with a coating comprising a compound with at least one aromatic ring having at least two hydroxyl groups borne by two adjacent carbon atoms of that aromatic ring and an ion of a transition metal, and ii) heating the food product thereafter in order to develop a color of the surface.

Thereby, the transition metal ions can be add-mixed directly into a composition or extract comprising the compound at a defined concentration and subsequently be applied together onto the surface of the food product. This solution allows simplifying the application of the invention to just one basic step of surface treatment and hence would reduce the costs of production.

“Heating” refers here to raising the temperature of the food product or particularly the surface of the food product to at least 40° C., preferably to at least 50° C., 60° C. or 70° C., and not exceeding 180° C. For heating with a microwave oven, the desired temperature is in the range from about 50° C. to 100° C.

An embodiment further pertains to a method, wherein the step i) of coating the surface comprises the steps of individually coating said surface first with the compound and thereafter with an ion of a transition metal, or vice versa. Thereby, a transition metal ion could be applied for example by spraying to a food surface either before or after the compound has been applied to said same surface. Advantageously, this allows separating the reactants, i.e. the compound and the transition metal ions, to better control the coloring reaction on the surface of the product.

A further embodiment pertains to the method of the invention, wherein the compound and/or the ion of the transition metal are encapsulated. Alternatively, a chemical base applied together with the compound or separately may be encapsulated.

Encapsulation technology is well known in the art and could be applied here for either the compound and/or the transition metal ions. Condition is that the encapsulation releases its enclosed substances once heated above a critical temperature. Advantageously, the two components, the compound and the metal ions, would not interact and react with each other while being encapsulated and present at the same time in the surface coating of a finished food product before the heating step. Upon heating, however, the compounds would be released from their encapsulation and could start to react and interact with each other. This would allow on one hand to improve color stability for increasing storage and distribution time of such coated food products, and on the other hand the perceived effect of surface coloring during the heating step could be significantly increased.

In a preferred embodiment the heating of the product is in a microwave oven from 250 to 1400 Watts, preferably from 600 to 1100 Watts. Advantageously, the method of the invention is used for products which are intended to be heated in a microwave oven, for example in-home by a consumer. Upon heating in the microwave oven, the product would then develop a brownish color at the surface, typical of a well baked and appetizing product. Such brownish colors depend with the application, food product type, the concentration and choice of the different reactants and can result in a variety of color aspects, reaching into violet, red, orange, golden-yellow, grey and blue.

A still further embodiment of the invention pertains to a composition for coating a food product comprising: i) a compound with at least one aromatic ring having at least two hydroxyl groups borne by two adjacent carbon atoms of that aromatic ring in a concentration from 1 to 100 mg/ml, preferably from 2.5 to 10 mg/ml; ii) an ion of a transition metal in a concentration from 0.2 to 100 mMol, preferably from 2 to 10 mMol; and iii) water.

Advantageously, such a composition comprises the optimal combination and concentrations of a selected compound with a selected ion from a transition metal for a specific product application. This would allow to simplify an industrial application of the invention as one composition can be prepared, stored if necessary, and finally applied to food product surfaces in one single processing step, for example in a factory. This would allow standardizing the application for assuring consistent and optimal product quality.

The food product of the present invention may be further coated with a solution comprising a chemical base applied to said surface together with or separately of the compound and the transition metal ions. Thereby, where applied together, the pH of an originally acidic composition can be adjusted e.g. to a pH value between pH 7 and pH 8.5, before applying said composition to a food surface. Alternatively, the chemical base can be applied separately to the surface either before or after applying the compound and transition metal ions, for example by spraying it directly onto said surface. As chemical base for example a solution of sodium bicarbonate such as conventional baking soda or sodium hydroxide can be applied.

The use of a chemical base together with the compound and the transition metal ions has the advantage of accelerating the development of the desired color reaction. Thereby, the color appearance develops faster and more intense upon heating of the product surface. Further, using a developer such as a chemical base allows reducing the amount of compound necessary for reaching the desired food coloring after the heating step. Hence, the objective to provide an as colorless food surface before heating and a well colored surface after heating can be even better achieved in this way.

Preferably, the composition of the invention further comprises an edible oil. This would allow to increase the viscosity of the composition to be applied to a food surface in such a way that said composition can be better applied and is retained in place on a surface for example on a dough crust upon application.

Those skilled in the art will understand that they can freely combine all features of the present invention disclosed herein. In particular, features described for the product of the present invention may be combined with the method of the present invention and vice versa.

Further advantages and features of the present invention are apparent from the examples.

### EXAMPLE 1

A tea extract can be obtained by conventional hot water extraction of tea leaves. For example, the amount of water used for the extraction may be from 4 to 20 parts by weight per part by weight of solid tea leaves. The duration of the extraction is typically up to 30 minutes or less. The temperature of the water used for the extraction may be any temperature conventionally used for such hot extraction of tea leaves, such as from about 60° C. to 125° C. The extraction of tea leaves may be carried out either in batch or continuous process mode with the aqueous extract being separated from the tea leaves for example by filtering or centrifugation. The resulting aqueous extract can be either used as such in the composition for the surface coating or be further concentrated for example by partial evaporation of water. The tea leaves for preparing the tea extract can be from any plant source conventionally known as being used for preparing a tea. Specifically, such tea varieties include but are not limited to black tea, green tea, oolong tea, white tea, yellow tea, or any blend thereof.

Alternatively, conventional instant tea powder, as can be found in the commerce, can be used and reconstituted with water to a tea extract. For example, an aqueous solution containing about 1-5 wt % of tea powder can be prepared.

A composition for surface coating can be prepared by adding for example 1 wt % of a 0.1 Mol stock solution of CuSO⁴ in de-mineralized water to the prepared tea extract solutions. Optionally, an edible oil or a binder or thickener as for example pectin, xanthan, agar, dextrin, a gum adhesive agent or another food-grade hydrocolloid, can be added to the composition in order to facilitate the technical applicability of the composition to a food product surface.

### EXAMPLE 2

50 g of pectin (Pectin Classic CU 401, Herbstreith & Fox KG, Germany) was dissolved in 2'000 g of de-mineralized water, heated at 60° C. for 1 hour and the pH adjusted with NaOH to pH 4.5. A 0.5 wt % stock solution of black tea extract (Advanced Nutra, Canada) was prepared by adding 0.5 g of dried black tea extract to 99.5 g of the pectin solution. A 1.5 M solution of zinc chloride was prepared in de-mineralized water. Then, three 15 mL aliquots of the black tea stock solution were prepared as follows:
a) 100 μL of the zinc chloride solution was added to the 15 mL black tea stock solution, which corresponds to a Zn salt concentration of 10 mM;
b) 10 μL of the zinc chloride solution was added to the 15 mL black tea stock solution, which corresponds to a Zn salt concentration of 1 mM;
c) 2 μL of the zinc chloride solution was added to the 15 mL black tea stock solution, which corresponds to a Zn salt concentration of 0.2 mM.
   Subsequently, about 0.55 g of each preparation was brushed onto the surface of a LEISI dough pastry sample covering about 44.2 cm² each, which corresponds to a concentration of extract of about 0.062 mg/cm² at the dough surface. The dough pastries were then cooked for 1 min 20 sec in a microwave oven (NN-255 Panasonic) at 600 Watts.

An additional set of experiments was carried out following the same procedure as described above. However, after application of the tea extract to the dough pastries, about 0.25 g of a 1 M solution of NaHCO₃ in water was sprayed onto the same dough surfaces before cooking in the microwave oven under the same conditions as above.

The results are shown in table 1 below. The addition of Zn ions induced a faster browning reaction which implied a decrease of the L* value (luminosity). The luminosity analysis was carried out using the CIELab* notation. In the International Commission on Illumination (CIE), the intensity of a color is measured in luminosity L (L=0: black, L=100: white). The analysis was registered using a computer controlled digital camera system (DigiEye, Verivide) with a D65 light source.

Zn ions in addition with sodium bicarbonate delivered the best browning option.

TABLE 1

| | | | 1′20 at | | No Heating | | 1′20 at 600 W | |
|---|---|---|---|---|---|---|---|---|
| | No Heating | | 600 W | | with NaHCO₃ | | with NaHCO₃ | |
| Black tea 0.062 mg/cm2 | L* | stdev | L* | stdev | L* | stdev | L* | stdev |
| Zinc chloride: | 93.1 | 0.8 | 87.9 | 1.2 | 91.87 | 1.1 | 76.5 | 2.4 |
| 0 mg/cm² | | | | | | | | |
| Zinc chloride: | 86.4 | 0.5 | 81.9 | 0.6 | 87.8 | 0.8 | 74.7 | 1.7 |
| 3.39E−04 mg/cm² | | | | | | | | |
| Zinc chloride: | 86.3 | 0.4 | 81.9 | 0.9 | 85.5 | 0.7 | 73.3 | 2.2 |
| 1.70E−03 mg/cm² | | | | | | | | |
| Zinc chloride: | 85.3 | 0.7 | 81.9 | 0.8 | 84.7 | 1 | 73.8 | 1.4 |
| 1.70E−02 mg/cm² | | | | | | | | |

Stdev = standard deviation

### EXAMPLE 3

50 g of pectin (Pectin Classic CU 401, Herbstreith & Fox KG, Germany) was dissolved in 2'000 g of de-mineralized water, heated at 60° C. for 1 hour and the pH adjusted with NaOH to pH 4.5. A 0.5 wt % stock solution of white tea extract (Advanced Nutra, Canada) was prepared by adding 0.5 g of dried white tea extract to 99.5 g of the pectin solution. A 0.15 M solution of ferrous gluconate hydrate was prepared in de-mineralized water. Then, three 15 mL aliquots of the white tea stock solution were prepared as follows:
a) 200 μL of the ferrous gluconate hydrate solution was added to 15 mL of the white tea stock solution, which corresponded to a Fe salt concentration of 2 mM;
b) 20 μL of the ferrous gluconate hydrate solution was added to 15 mL of the white tea stock solution, which corresponds to a Fe salt concentration of 0.2 mM;
c) 2 μL of the ferrous gluconate hydrate solution was added to 15 mL of the white tea stock solution, which corresponds to a Fe salt concentration of 0.02 mM.
   Subsequently, about 0.55 g of each solution was brushed onto the surface of a LEISI dough pastry sample covering about 44.2 cm² each (circle having a diameter of 7.5 cm), which corresponds to a concentration of extract of about 0.062 mg/cm² at the dough surface. The dough pastries were then cooked for 1 min 20 sec in a microwave oven (NN-255 Panasonic) at 600 Watts.

An additional set of experiments was carried out following the same procedure as described above. However, after application of the tea extract to the dough pastries, about 0.25 g of a 1 M solution of NaHCO₃ in water was sprayed onto the same dough surfaces before cooking in the microwave oven under the same conditions as above.

The results are shown in table 2 below. The addition of Fe (II) ions induced a faster browning reaction which implied a decrease of the L* value (luminosity). Fe (II) ions in addition with sodium bicarbonate delivered the best browning option.

TABLE 2

| | | | 1′20 at | | No Heating | | 1′20 at 600 W | |
|---|---|---|---|---|---|---|---|---|
| | No Heating | | 600 W | | with NaHCO₃ | | with NaHCO₃ | |
| White tea 0.062 mg/cm2 | L* | stdev | L* | stdev | L* | stdev | L* | stdev |
| Ferrous Gluconate: | 95.9 | 1 | 94 | 0.8 | 92.9 | 0.6 | 81.8 | 1.3 |
| 0 mg/cm² | | | | | | | | |
| Ferrous Gluconate: | 87.3 | 0.6 | 83.7 | 0.7 | 86.8 | 0.5 | 78.3 | 1.4 |
| 1.11E−04 mg/cm² | | | | | | | | |
| Ferrous Gluconate: | 86.4 | 0.3 | 82.3 | 0.9 | 83.8 | 0.9 | 75.6 | 1.4 |
| 1.11E−03 mg/cm² | | | | | | | | |
| Ferrous Gluconate: | 81.7 | 1.2 | 79.2 | 0.8 | 73 | 1 | 65.7 | 1.8 |
| 1.11E−02 mg/cm² | | | | | | | | |

### EXAMPLE 4

50 g of pectin (Pectin Classic CU 401, Herbstreith & Fox KG, Germany) was dissolved in 2'000 g of de-mineralized water, heated at 60° C. for 1 hour and the pH adjusted with NaOH to pH 4.5. A 0.5 wt % stock solution of green tea extract GTFTX (Nestlé, Switzerland) was prepared by adding 0.5 g of dried green tea extract to 99.5 g of the pectin solution. A 1.5 M solution of manganese chloride was prepared in de-mineralized water. Then, three 15 mL aliquots of the green tea stock solution were prepared as follows:
a) 100 μL of the manganese chloride solution was added to 15 mL of the green tea stock solution, which corresponds to a Mn salt concentration of 10 mM;
b) 10 μL of the manganese chloride solution was added to 15 mL of the green tea stock solution, which corresponds to a Mn salt concentration of 1 mM;
c) 2 μL of the manganese solution was added to 15 mL of the green tea stock solution, which correspond to a Mn salt concentration of 0.2 mM.
   Subsequently, about 0.55 g of each solution was brushed onto the surface of a LEISI dough pastry sample covering about 44.2 cm² each (circle having a diameter of 7.5 cm), which corresponds to a concentration of extract of about 0.062 mg/cm² at the dough surface. The dough pastries were then cooked for 1 min 20 sec in a microwave oven (NN-255 Panasonic) at 600 Watts.

An additional set of experiments was carried out following the same procedure as described above. However, after application of the tea extract to the dough pastries, about 0.25 g of a 1 M solution of NaHCO₃ in water was sprayed onto the same dough surfaces before cooking in the microwave oven under the same conditions as above.

The results are shown in table 3 below. The addition of Mn ions induced a slightly faster browning reaction which implied a decrease of the L* value (luminosity). Mn ions in addition with sodium bicarbonate delivered the best browning option.

TABLE 3

| | | | 1′20 at | | No Heating | | 1′20 at 600 W | |
|---|---|---|---|---|---|---|---|---|
| | No Heating | | 600 W | | with NaHCO₃ | | with NaHCO₃ | |
| Green tea 0.062 mg/cm² | L* | stdev | L* | stdev | L* | stdev | L* | stdev |
| Manganese chloride: | 94.6 | 0.3 | 90.3 | 0.9 | 93.8 | 0.5 | 78.5 | 1.2 |
| 0 mg/cm² | | | | | | | | |
| Manganese chloride: | 90.5 | 0.5 | 88.8 | 1.1 | 89.1 | 0.4 | 75.4 | 2.7 |
| 3.1E−04 mg/cm² | | | | | | | | |
| Manganese chloride: | 90.5 | 0.4 | 86.3 | 1 | 89.5 | 1 | 77.1 | 1.7 |
| 1.6E−03 mg/cm² | | | | | | | | |
| Manganese chloride: | 90.4 | 0.3 | 85.9 | 0.7 | 88 | 0.5 | 75.5 | 1.3 |
| 1.6E−02 mg/cm² | | | | | | | | |

### EXAMPLE 5

Several trials with grape seed extracts from different suppliers were carried out. The grape seed extracts used are the following: grape seed (Naturex, France), Gravinol-T (Kikkomann, Japan), Vinoseed (Bioserae, France).

7.5 g of pectin (Pectin Classic CU 201, Herbstreith & Fox KG, Germany) was dissolved in 292.5 g of de-mineralized water, heated at 60° C. for 1 hour and the pH adjusted with NaOH to pH 4.5. A 0.5 wt % stock solution of each grape seed extract was prepared by adding 0.25 g of dried extract to 49.75 g of pectin solution. Salts containing transition metals, such as manganese and iron, were added thereafter as follows. Iron ions from ferrous gluconate hydrate were added to each grape seed extract solution to result in a 2 mM concentration of iron ions. Similar solutions were prepared with manganese ions coming from manganese chloride to result in a 10 mM concentration of manganese ions. Subsequently, about 0.9 g of each extract solution was brushed onto dough surfaces covering about 60 cm², which corresponds to a surface concentration of extract of about 0.075 mg/cm². The dough buns were then cooked for 1 min 30 sec in a microwave oven (NN-255 Panasonic) at 750 Watts.

An additional set of experiments was carried out following the same procedure as described above. However, after application of the grape seed extract to the dough buns, about 0.45 g of a 1 M solution of baking soda in water was sprayed onto the same dough surfaces before cooking in the microwave oven under the same conditions as above.

The results are shown in FIGS. 1 and 2. It was observed that the coloring is more pronounced when metal ions are present together with the grape seed extract on the bread surface. With the addition of baking soda, the resulting surface colors were even more intensive and became more brownish with manganese and more violet with iron.

### EXAMPLE 6

50 g of pectin (Pectin Classic CU 401, Herbstreith & Fox KG, Germany) was dissolved in 2'000 g of de-mineralized water, heated at 60° C. for 1 hour and the pH adjusted with NaOH to pH 4.5. First, a 1 wt % solution of chlorogenic acid (Sigma-Aldrich, Germany) was prepared by adding 2.5 g of chlorogenic acid in 247.5 g of the pectin solution. Then, the chlorogenic acid solution was further diluted 4× in pectin solution to result in a 0.25 wt % solution of chlorogenic acid. A 0.5 wt % solution of caffeic acid (Sigma-Aldrich, Switzerland) was prepared by adding 0.5 g caffeic acid in 99.5 g pectin solution, which was then further diluted 2× to a 0.25 wt % caffeic acid solution.

The 0.25 wt % chlorogenic acid and the 0.25 wt % caffeic acid solutions were used. Salts containing transition metals, such as manganese and iron, were added to those solutions. Fe ions from ferrous gluconate hydrate were added to each solution to result in a 2 mM concentration of Fe ions. Similar solutions were prepared with Mn ions coming from manganese chloride to result in a 10 mM concentration of Mn ions.

Subsequently, about 0.4 g of the solutions were brushed onto round cookie raw dough surfaces covering about 33.2 cm² (circle having a diameter of 6.5 cm), which corresponds to a concentration of chlorogenic and caffeic acid of about 0.03 mg/cm² at the cookie dough surface, respectively. Thereafter, about 0.2 g of a 1 M solution of baking soda in water was sprayed onto the same dough surfaces before cooking in the microwave for 1 min 20 sec in a microwave oven (NN-255 Panasonic) at 600 Watts.

The results are shown in FIG. 3. The heating step induced a decrease of the L* (luminosity), as well as a change in the a* (green to red) and b* (blue to yellow) values. This resulted in clearly darker brown surfaces and with some modulation of the overall color aspect.

### EXAMPLE 7

Different extracts from plant materials have been tested. Thereby, plum extract was selected because of its natural high amount of 3-caffeoylquinic acid compounds, rosemary extract for its natural high amount of rosmarinic acid, and green coffee extract for its natural high amount of chlorogenic and caffeic acid.

50 g of pectin (Pectin Classic CU 401, Herbstreith & Fox KG, Germany) was dissolved in 2'000 g of de-mineralized water, heated at 60° C. for 1 hour and the pH adjusted with NaOH to pH 4.5. Each a 1 wt % solution of plum extract (Maypro, US), celery extract (Martin Bauer Group, Germany), rosemary extract (Duas Rodas Industrial Ltda., Brasil) and green coffee extract (Duas Rodas Industrial Ltda., Brasil) were prepared by adding 1.5 g of each extract to 148.5 g of a pectin solution.

Salts containing transition metals, such as manganese and iron, were added as follows: Fe ions from ferrous gluconate hydrate were added to each solution to result in a 2 mM concentration. Similar solutions were prepared with Mn ions from manganese chloride to result in a 10 mM concentration.

Subsequently, about 0.45 g of each extract solution was brushed onto the surface of a round LEISI pastry dough covering about 44.2 cm² (circle having a diameter of 7.5 cm), which corresponds to a concentration of the extracts of about 0.10 mg/cm² at the dough surface. The dough pastries were then cooked for 1 min 20 sec in a microwave oven (NN-255 Panasonic) at 600 Watts.

An additional set of experiments was carried out following the same procedure as described above. However, after application of the extract solutions to the dough surfaces, about 0.2 g of a 1 M solution of baking soda in water was sprayed onto the same dough surfaces before cooking in the microwave oven under the same conditions as above.

The results with the Mn supplementation are shown in FIG. 4. The heating step induced an increase of the b* value which indicated that the amount of yellow increased, even more so for the neutral surface coatings. A decrease of the L* (luminosity) was also perceived and the overall color aspect became more dark.

The results with the Fe supplementation are shown in FIG. 5. The heating step induced an increase of the a* (green to red) and b* (blue to yellow) value, indicating a significant shift in the overall color aspect.

Furthermore, the L* (luminosity) decreases drastically and the color of the surfaces became much darker.

1. A food product having a coating on a surface, the coating comprising: a compound with at least one aromatic ring having at least two hydroxyl groups borne by two adjacent carbon atoms of that aromatic ring; and an ion of a transition metal.

2. The food product of claim 1, wherein the coating is colorless before the food product is heated.

3. The food product of claim 1, wherein the compound is selected from the group consisting of caffeic acid, cholorogenic acid, rosmarinic acid, caftaric acid, quercetin, catechin, epi-catechin and (epi)-gallocatechin, and combinations thereof.

4. The food product of claim 1, wherein the compound is in a form of a plant extract selected from the group consisting of tea, coffee, grape, grape seed, plum, celery, basil, thyme, oregano, rosemary and onion extract, and combinations thereof.

5. The food product of claim 1, wherein the amount of the compound on the surface of the food product is from 0.001-1.0 mg/cm².

6. The food product of claim 1, wherein the amount of the ion of the transition metal on the surface of the product is from 0.00001-1.0 mg/cm².

7. The food product of claim 1, wherein the transition metal is selected from the group consisting of Zn, Fe, Cu and Mn, and combinations thereof.

8. The food product of claim 1, wherein the product is a frozen food product.

9. The food product of claim 1, wherein the food product is selected from the group consisting of dough, bread, cookies, cereals, pizzas, snacks, gratins, cooked pasta, lasagna, cheese and rice dishes.

10. A method for coloring a surface of a food product when heated, comprising the steps of: coating the surface with a coating comprising a compound with at least one aromatic ring having at least two hydroxyl groups borne by two adjacent carbon atoms of that aromatic ring and an ion of a transition metal; and heating the food product thereafter in order to develop a color of the surface.

11. The method of claim 10, wherein the coating step includes the steps of individually coating the surface first with the compound and thereafter with an ion of a transition metal, or vice versa.

12. The method of claim 10, wherein the compound and/or the ion of the transition metal are encapsulated.

13. The method of claim 10, wherein the heating of the food product is in a microwave oven.

14. A composition for coating a food product comprising: a compound with at least one aromatic ring having at least two hydroxyl groups borne by two adjacent carbon atoms of that aromatic ring in a concentration from 1 to 100 mg/ml; an ion of a transition metal in a concentration from 0.2 to 100 mMol; and water.

15. The composition of claim 14 further comprising an edible oil.
